(19) United States
(12) Patent Application Publication
(10) Pub. No.: US 2026/0045422 A1
(43) Pub. Date: Feb. 12, 2026

(54) Ultracapacitors For E-Latch Applications

(71) Applicant: KYOCERA AVX Components Corporation, Fountain Inn, SC (US)

(72) Inventors: Xiaorong Liu, Simpsonville, SC (US); Matt Tenuto, Greenville, SC (US); Ken Brown, Simponsville, SC (US); Bryan Caoile, Simpsonville, SC (US); Jonathan Robert Knopsnyder, Fountain Inn, SC (US); Jean-Yves Pallard, Saint-Apollinaire (FR)

(21) Appl. No.: 19/290,418

(22) Filed: Aug. 5, 2025

Related U.S. Application Data
(60) Provisional application No. 63/680,126, filed on Aug. 7, 2024.

(51) Int. Cl. H01G 11/26; B60L 1/00; E05B 81/86; H01G 11/34

(52) U.S. Cl. CPC H01G 11/26; B60L 1/003; E05B 81/86; H01G 11/34

(57) ABSTRACT

An ultracapacitor that comprises a first electrode, a second electrode, a separator, a nonaqueous electrolyte, and a housing is provided. The first electrode comprises a first current collector electrically coupled to a first carbonaceous coating that comprises activated carbon particles having a first plurality of pores and the second electrode comprises a second current collector electrically coupled to a second carbonaceous coating that comprises activated carbon particles having a second plurality of pores. The separator is positioned between the first electrode and the second electrode. The nonaqueous electrolyte is in ionic contact with the first electrode and the second electrode and contains an ionic liquid comprising a cationic species and a counterion dissolved in a nonaqueous solvent. The first plurality of pores of the first carbonaceous coating has a median pore diameter size, the counterion has a median ionic radius size, and the ratio of the median pore diameter size of the first plurality of pores to the median ionic radius size of the counterion is about 0.5 to about 1.5. A module comprising at least two ultracapacitors, an energy reserve system for electronic latch assemblies, and a vehicle with an energy reserve system for electronic latch assemblies is also provided.

### RELATED APPLICATION

The present application is based upon and claims priority to U.S. Provisional Patent Application Ser. No. 63/680,126, having a filing date of Aug. 7, 2024, which is incorporated herein by reference.

### BACKGROUND OF THE INVENTION

Electrical energy storage cells are widely used to provide power to electronic, electromechanical, electrochemical, and other useful devices, such as electronic latch assemblies. Electronic latch assemblies may be used in a variety of applications, such as in vehicles and asset security systems. Electric double layer capacitors are used in electronic latch assemblies as a form of energy source. An electric double layer capacitor, for instance, generally employs a pair of polarizable electrodes that contain carbon particles impregnated with a liquid electrolyte. However, problems remain with using conventional ultracapacitors as an energy source in electronic latch assemblies, as conventional ultracapacitors have varying voltage retention rates due to self-discharge and therefore, unreliable amounts of energy. This can lead to other issues arising from using conventional ultracapacitors in electronic latch assemblies, such as unwanted operation of the electronic latch assembly, or worse, such as a lack of ability to provide energy to the electronic latch assembly during an emergency situation. As such, a need currently exists for an improved ultracapacitor.

### SUMMARY OF THE INVENTION

In accordance with one embodiment of the present invention, an ultracapacitor is disclosed that comprises a first electrode, a second electrode, a separator, a nonaqueous electrolyte, and a housing. The first electrode comprises a first current collector electrically coupled to a first carbonaceous coating that comprises activated carbon particles having a first plurality of pores and the second electrode comprises a second current collector electrically coupled to a second carbonaceous coating that comprises activated carbon particles having a second plurality of pores. The separator is positioned between the first electrode and the second electrode. The nonaqueous electrolyte is in ionic contact with the first electrode and the second electrode, wherein the nonaqueous electrolyte contains an ionic liquid comprising a cationic species and a counterion dissolved in a nonaqueous solvent. The first electrode, the second electrode, the separator, and the electrolyte are retained within the housing. The first plurality of pores of the first carbonaceous coating has a median pore diameter size, the counterion has a median ionic radius size, and the ratio of the median pore diameter size of the first plurality of pores to the median ionic radius size of the counterion is from about 0.5 to about 1.5.

In accordance with a second embodiment of the present invention, an energy reserve system for an electronic latch assembly is disclosed. The energy reserve system comprises an electronic control unit connected to a locking mechanism of the electronic latch assembly and at least two ultracapacitors that are conductively connected, wherein the at least two ultracapacitors provide voltage to the electronic control unit to configure the locking mechanism. Each ultracapacitor comprises a first electrode, a second electrode, a separator, a nonaqueous electrolyte, and a housing. The first electrode comprises a first current collector electrically coupled to a first carbonaceous coating that comprises activated carbon particles having a first plurality of pores and the second electrode comprises a second current collector electrically coupled to a second carbonaceous coating that comprises activated carbon particles having a second plurality of pores. The separator is positioned between the first electrode and the second electrode. The nonaqueous electrolyte is in ionic contact with the first electrode and the second electrode, wherein the nonaqueous electrolyte contains an ionic liquid comprising a cationic species and a counterion dissolved in a nonaqueous solvent. The first electrode, the second electrode, the separator, and the electrolyte are retained within the housing. The first plurality of pores of the first carbonaceous coating has a median pore diameter size, the counterion has a median ionic radius size, and the ratio of the median pore diameter size of the first plurality of pores to the median ionic radius size of the counterion of is from about 0.5 to about 1.5.

In accordance with another embodiment of the present invention, a module is disclosed that comprises at least two ultracapacitors conductively connected. Each ultracapacitor comprises a first electrode, a second electrode, a separator, a nonaqueous electrolyte, and a housing. The first electrode comprises a first current collector electrically coupled to a first carbonaceous coating that comprises activated carbon particles having a first plurality of pores and the second electrode comprises a second current collector electrically coupled to a second carbonaceous coating that comprises activated carbon particles having a second plurality of pores. The separator is positioned between the first electrode and the second electrode. The nonaqueous electrolyte is in ionic contact with the first electrode and the second electrode, wherein the nonaqueous electrolyte contains an ionic liquid comprising a cationic species and a counterion dissolved in a nonaqueous solvent. The first electrode, the second electrode, the separator, and the electrolyte are retained within the housing. The first plurality of pores of the first carbonaceous coating has a median pore diameter size, the counterion has a median ionic radius size, and the ratio of the median pore diameter size of the first plurality of pores to the median ionic radius size of the counterion of is from about 0.5 to about 1.5.

In accordance with a further embodiment of the present invention, a vehicle is disclosed. The vehicle comprises a frame, at least one door, and an energy reserve system for an electronic latch assembly. The energy reserve system comprises an electronic control unit and at least two ultracapacitors. The electronic control unit is connected to a locking mechanism of the electronic latch assembly and at least two ultracapacitors are conductively connected and provide voltage to the electronic control unit to configure the locking mechanism. Each ultracapacitor comprises a first electrode, a second electrode, a separator, a nonaqueous electrolyte, and a housing. The first electrode comprises a first current collector electrically coupled to a first carbonaceous coating that comprises activated carbon particles having a first plurality of pores and the second electrode comprises a second current collector electrically coupled to a second carbonaceous coating that comprises activated carbon particles having a second plurality of pores. The separator is positioned between the first electrode and the second electrode. The nonaqueous electrolyte is in ionic contact with the first electrode and the second electrode, wherein the nonaqueous electrolyte contains an ionic liquid comprising a cationic species and a counterion dissolved in a nonaqueous solvent. The first electrode, the second electrode, the separator, and the electrolyte are retained within the housing. The first plurality of pores of the first carbonaceous coating has a median pore diameter size, the counterion has a median ionic radius size, and the ratio of the median pore diameter size of the first plurality of pores to the median ionic radius size of the counterion of is from about 0.5 to about 1.5.

Other features and aspects of the present invention are set forth in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figure in which:

FIG. 1 graphically illustrates the results of Example 1, which demonstrates the voltage retention rates for ultracapacitors with different electrode thickness configurations;

FIG. 2 graphically illustrates the results of Example 2, which demonstrates the voltage retention rates for ultracapacitors with various electrolytes;

FIG. 3 graphically illustrates the results of Example 3, which demonstrates the voltage retention rates for ultracapacitors with different electrode materials and thickness configurations;

FIG. 4 graphically illustrates the results of Example 4, which demonstrates the voltage retention rates for ultracapacitors with different electrode materials and various electrolytes;

FIG. 5 graphically illustrates the results of Example 5, which demonstrates the voltage retention rates for ultracapacitors with different thickness configurations and various electrolytes;

FIG. 6 illustrates an energy reserve system; and

FIG. 7 illustrates a vehicle with an energy reserve system.

Repeat use of reference characters in the present specification and drawing is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only and is not intended as limiting the broader aspects of the present invention, which broader aspects are embodied in the exemplary construction.

Generally speaking, the present invention is directed to an ultracapacitor that contains a first electrode that contains a first carbonaceous coating electrically coupled to a first current collector and a second electrode that contains a second carbonaceous coating electrically coupled to a second current collector. The activated carbon of the first carbonaceous coating comprises a first plurality of pores and the activated carbon of the second carbonaceous coating comprises a second plurality of pores. A separator is also positioned between the first electrode and the second electrode, and a nonaqueous electrolyte is in ionic contact with the first electrode and the second electrode. The nonaqueous electrolyte contains an ionic liquid comprising a cationic species and a counterion dissolved in a nonaqueous solvent. The first electrode, second electrode, separator, and electrotype are retained within a housing.

The present inventors have discovered that through selective control over the particular nature of the electrolyte, the size of the pores of the activated carbon in the carbonaceous coatings, and/or the thickness of the electrodes, a variety of beneficial properties may be achieved. More particularly, selective control over the particular nature of these features has been found to result in an ultracapacitor that is a more reliable energy source, which makes it particularly suitable for use in electronic (e.g., “e-latch”) assemblies.

For instance, as one example, the present inventors have discovered that selectively controlling the combination of the electrolyte and the activated carbon can achieve several benefits. In general, the nonaqueous electrolyte contains an ionic liquid comprising a cationic species and a counterion that is dissolved in a nonaqueous solvent. Particularly suitable cations have a median ionic radius size of greater than about 0.10 nanometers, such as greater than about 0.11 nanometers, such as greater than about 0.12 nanometers, such as greater than about 0.13 nanometers, such as greater than about 0.14 nanometers, such as greater than 0.15 nanometers, such as greater than 0.16 nanometers, such as greater than about 0.17 nanometers, such as greater than about 2.0 nanometers, such as greater than about 2.5 nanometers. In other embodiments, particularly suitable cations have a median ionic radius size of less than about 1.0 nanometers, such as less than about 0.5 nanometers, such as less than about 0.3 nanometers, such as less than about 0.25 nanometers, such as less than about 0.2 nanometers, such as less than about 0.19 nanometers, such as less than about 0.18 nanometers, such as less than about 0.17 nanometers. In certain embodiments, the ionic radius may be the solvated ionic radius if the ions are in liquid solutions, such that the median ionic radius takes into account the radius of the ion and the solvation shell. In preferred embodiments, suitable cations include tetraethylammonium, triethylmethylammonium, spiro-(1,1′)-bipyrrolidinium, N,N′-dimethylpiperazine, and 1,1-dimethylpyrrolidinium.

Particularly suitable counterions have a median ionic radius size of greater than about 0.03 nanometers, such as greater than about 0.04 nanometers, such as greater than about 0.05 nanometers, such as greater than about 0.06 nanometers, such as greater than about 0.07 nanometers, such as greater than about 0.08 nanometers, such as greater than about 0.09 nanometers, such as greater than about 0.10 nanometers. In other embodiments, particularly suitable counterions have a median ionic radius size of less than about 1.0 nanometers, such as less than about 0.5 nanometers, such as less than about 0.2 nanometers, such as less than about 0.15 nanometers, such as less than about 0.14 nanometers, such as less than about 0.13 nanometers, and such as less than about 0.125 nanometers. In certain embodiments, the ionic radius may be the solvated ionic radius if the ions are in liquid solutions, such that the median ionic radius takes into account the radius of the ion and the solvation shell. In preferred embodiments, suitable counterions include tetrafluoroborate and bis(oxolato)borate.

Suitable ionic liquid displays a ratio of the median ionic radius size of the cationic species to the median ionic radius size of the counterion of greater than about 1.0, such as greater than about 1.5, such as greater than about 2.0, such as greater than about 2.5, such as greater than about 3.0, such as greater than about 3.5, such as greater than about 4.0, such as greater than about 4.5, such as greater than about 5.0. In other embodiments, the ionic liquid displays a ratio of the median ionic radius size of the cationic species to the median ionic radius of the counterion of less than about 10.0, such as less than about 9.0, such as less than about 8.0, such as less than about 7.0. In certain embodiments, the ionic liquid displays a ratio of the median ionic radius size of the cationic species to the median ionic radius size of the counterion of greater than about 3.0, such as greater than about 3.5, such as greater than about 4.0. In preferred embodiments, the ratio of the median ionic radius size of the cationic species to the median ionic radius size of the counterion is from about 1.0 to about 5.0.

Without intending to be limited by theory, the present inventors have found that when the ionic liquid displays a ratio of the median ionic radius size of the cationic species to the median ionic radius size of the counterion of greater than about 1, such as greater than about 3, that the amount of free migration of ions flowing between the electrodes is reduced. This reduction in ion migration may allow for more stable electrodes and increased voltage retention rates of the overall ultracapacitor. Particularly, this decrease in free migration results in a more stable negative electrode.

Notably, the present inventors have discovered that selectively controlling the porosity profile of the activated carbon can also result in favorable interactions with the ionic liquid. For instance, in certain embodiments, it may be desired to selectively control certain aspects of the activated carbon particles, such as their particle size distribution, surface area, and pore size distribution to help reduce ion mobility for certain types of electrolytes after being subjected to one or more charge-discharge cycles. For example, at least 50% by volume of the particles (D50 size) may have a size in the range of from about 0.01 to about 30 micrometers, in some embodiments from about 0.1 to about 20 micrometers, and in some embodiments, from about 0.5 to about 10 micrometers. At least 90% by volume of the particles (D90 size) may likewise have a size in the range of from about 2 to about 40 micrometers, in some embodiments from about 5 to about 30 micrometers, and in some embodiments, from about 6 to about 15 micrometers.

The BET surface area may also range from about 900 m²/g to about 3,000 m²/g, in some embodiments from about 1,000 m²/g to about 2,500 m²/g, and in some embodiments, from about 1,100 m²/g to about 1,800 m²/g. In certain embodiments, the BET surface area of the activated carbon particles may be about 1,300 m²/g or greater, such as 1,400 m²/g or greater, such as 1,500 m²/g or greater. In other embodiments, the BET surface area of the activated carbon particles may be about 1,750 m²/g or less, such as 1,700 m²/g or less, such as about 1,600 m²/g or less.

In addition to having a certain size and surface area, the activated carbon particles may also contain pores having a certain size distribution. Without intending to be limited by theory, the present inventors have found that selectively controlling the pore size of the activated carbon particles of the first and second carbonaceous coatings, in addition to selectively controlling the electrolyte and/or the thickness of the carbonaceous coatings, can reduce ionic mobility of the cationic species and the counterion. For instance, the present inventors have found that selectively matching the pore size of the activated carbon particles of the carbonaceous coating to the size of the ions can reduce ionic mobility, especially if the pore size of the first carbonaceous coating is reduced so that it matches the size of the counterions. Therefore, the pores of the first carbonaceous coating no longer allow the small counterions to freely flow into them and rather act to “hold” the counterions. This reduction in ionic mobility due to the blocking of counterions from entering the pores of the first carbonaceous coating is referred to as the “threshold” effect.

For instance, in certain embodiments, the first plurality of pores of the first carbonaceous coating has a first total pore volume, the first total pore volume comprising about 50 vol. % or more of pores having a median pore diameter size of about 2 nanometers (i.e., “micropores”) or less, such as about 55 vol. % or more of pores having a median pore diameter size of about 2 nanometers or less, such as about 60 vol. % or more of pores having a median pore diameter size of about 2 nanometers or less, such as about 65 vol. % or more of pores having a median pore diameter size of about 2 nanometers or less, such as about 70 vol. % or more of pores having a median pore diameter size of about 2 nanometers or less, such as about 75 vol. % or more of pores having a median pore diameter size of about 2 nanometers or less. In other embodiments, the first total pore volume comprises about 100 vol. % or less of pores having a median pore diameter size of about 2 nanometers or less, such as about 95 vol. % or less of pores having a median pore diameter size of about 2 nanometers or less, such as about 90 vol. % or less of pores having a median pore diameter size of about 2 nanometers or less, such as about 85 vol. % or less of pores having a median pore diameter size of about 2 nanometers or less.

The total pore volume of the carbon particles in the first plurality of pores may be in the range of from about 0.2 cm³/g to about 1.5 cm³/g, and in some embodiments, from about 0.4 cm³/g to about 1.0 cm³/g. In other embodiments, the total pore volume of the carbon particles in the first plurality of pores is about 0.97 cm³/g. In certain embodiments, the single point adsorption total pore volume of pores less than about 3,650 Å at about p/p°=1.0 is about 0.800 m³/g or more, such as about 0.840 m³/g or more, such as about 0.880 m³/g or more, such as about 0.900 m³/g or more, and in some embodiments, such as about 0.950 m³/g or less, such as about 0.930 m³/g or less, such as about 0.920 m³/g or less, such as about 0.910 m³/g or less.

The amount of pores between about 2 nanometers and about 50 nanometers in size (i.e., “mesopores”) may likewise be from about 20 vol. % to about 50 vol. %, in some embodiments from about 25 vol. % to about 45 vol. %, and in some embodiments, from about 35 vol. % to about 40 vol. % of the first pore volume. For instance, in some embodiments, the amount of pores between about 2 nanometers to about 50 nanometers in size may be about 5 vol. % or more, such as about 10 vol. % or more, such as about 15 vol. % or more, such as about 20 vol. % or more, such as about 25 vol % or more, such as about 30 vol. % or more, such as about 35 vol. % or more, such as about 40 vol. % or more. In other embodiments, the amount of pores between about 2 nanometers to about 50 nanometers in size may be about 60 vol. % or less, such as about 55 vol. % or less, such as about 50 vol. % or less, such as about 45 vol. % or less.

The amount of pores greater than about 50 nanometers in size (i.e., “macropores”) may be from about 1 vol. % to about 50 vol. %, in some embodiments from about 5 vol. % to about 40 vol. %, and in some embodiments, from about 10 vol. % to about 35 vol. % of the first pore volume. For instance, in some embodiments, the amount of pores greater than about 50 nanometers in size may be about 1 vol. % or more, such as about 5 vol. % or more, such as about 10 vol. % or more, such as about 15 vol. % or more, such as about 20 vol. % or more, such as about 25 vol. % or more. In other embodiments, the amount of pores greater than about 50 nanometers in size may be about 50 vol. % or less, such as about 45 vol. % or less, such as about 40 vol. % or less, such as about 35 vol. % or less, such as about 30 vol. % or less.

In certain embodiments, the first plurality of pores of the first carbonaceous coating have a median pore diameter size, the counterion of the ionic liquid has a median ionic radius size, and the ratio of the median pore diameter size of the first plurality of pores to the median ionic radius size of the counterion of from about 0.5 or greater, such as from about 0.6 or greater, such as from about 0.7 or greater, such as from about 0.8 or greater, such as from about 0.9 or greater, and such as from about 1.0 or greater. In other embodiments, the ratio of the median pore diameter size of the first plurality of pores to the median ionic radius size of the counterion is from about 1.5 or less, such as from about 1.4 or less, such as from about 1.3 or less, such as from about 1.2 or less, and such as from about 1.1 or less.

In preferred embodiments, the ratio of the median pore diameter size of the first plurality of pores to the median ionic radius size of the counterion is about 0.95 to about 1.05. For instance, in certain embodiments, the ratio of the median pore diameter size of the first plurality of pores to the median ionic radius size of the counterion is about 0.95 or greater, such as about 0.96 or greater, such as about 0.97 or greater, such as about 0.98 or greater, such as about 0.99 or greater, such as about 1.0 or greater. In other embodiments, the ratio of the median pore diameter size of the first plurality of pores to the median ionic radius size of the counterion is about 1.05 or less, such as about 1.04 or less, such as about 1.03 or less, such as about 1.02 or less, such as about 1.01 or less. In other preferred embodiments, the ratio of the median pore diameter size of the first plurality of pores to the median ionic radius size of the counterion is about 1, such that the counterion is able to match the size of the pore.

It should also be understood that in some embodiments, the first electrode also includes a third carbonaceous coating. Thus, in certain embodiments, the first electrode includes a first carbonaceous coating on a first side of the first current collector and a third carbonaceous coating on a second and opposite side of the first current collector. In preferred embodiments, the third carbonaceous coating comprises the same material and the same porosity profile as the first carbonaceous coating.

As indicated, the ultracapacitor includes an electrolyte. The electrolyte is generally nonaqueous in nature and thus contains at least one nonaqueous solvent. To help extend the operating temperature range of the ultracapacitor, the nonaqueous solvent has a relatively high boiling temperature, such as about 150° C. or more, in some embodiments about 200° C. or more, and in some embodiments, from about 220° C. to about 300° C. Particularly suitable high boiling point solvents may include, for instance, cyclic carbonate solvents, such as ethylene carbonate, propylene carbonate, butylene carbonate, vinylene carbonate, etc. Propylene carbonate is particularly suitable due to its high electric conductivity and decomposition voltage, as well as its ability to be used over a wide range of temperatures. Of course, other nonaqueous solvents may also be employed, either alone or in combination with a cyclic carbonate solvent. Examples of such solvents may include, for instance, open-chain carbonates (e.g., dimethyl carbonate, ethyl methyl carbonate, diethyl carbonate, etc.), aliphatic monocarboxylates (e.g., methyl acetate, methyl propionate, etc.), lactone solvents (e.g., butyrolactone valerolactone, etc.), nitriles (e.g., acetonitrile, glutaronitrile, adiponitrile, methoxyacetonitrile, 3-methoxypropionitrile, etc.), amides (e.g., N,N-dimethylformamide, N,N-diethylacetamide, N-methylpyrrolidinone), alkanes (e.g., nitromethane, nitroethane, etc.), sulfur compounds (e.g., sulfolane, dimethyl sulfoxide, dimethyl sulfone etc.); and so forth. In preferred embodiments, the solvents may comprise sulfolane, dimethyl sulfone, acetonitrile, or combinations thereof.

The electrolyte also contains at least one ionic liquid, which is dissolved in the nonaqueous solvent. Typically, the ionic liquid is present at a relatively high concentration. For example, the ionic liquid may be present in an amount of about 1.0 mole per liter (M) of the electrolyte or more, in some embodiments about 1.2 M or more, in some embodiments about 1.3 M or more, and in some embodiments about 1.4 or more. In other embodiments, the ionic liquid may be present in an amount of about 3.0 M or less, in some embodiments about 2.5 M or less, and in some embodiments about 2.0 M or less. In certain embodiments, the ionic liquid may be present in an amount of about 1.4 M to about 1.8 M. In other embodiments, the ionic liquid may be present in an amount of about 1.0 M to about 2.0 M.

The ionic liquid is generally a salt having a relatively low melting temperature, such as about 400° C. or less, in some embodiments about 350° C. or less, in some embodiments from about 1° C. to about 100° C., and in some embodiments, from about 5° C. to about 50° C. The salt contains a cationic species and counterion. The cationic species contains a compound having at least one heteroatom (e.g., nitrogen or phosphorous) as a “cationic center.” Examples of such heteroatomic compounds include, for instance, unsubstituted or substituted organoquaternary ammonium compounds, such as ammonium (e.g., trimethylammonium, tetraethylammonium, etc.), pyridinium, pyridazinium, pyramidinium, pyrazinium, imidazolium, pyrazolium, oxazolium, triazolium, thiazolium, quinolinium, piperidinium, pyrrolidinium, quaternary ammonium spiro compounds in which two or more rings are connected together by a spiro atom (e.g., carbon, heteroatom, etc.), quaternary ammonium fused ring structures (e.g., quinolinium, isoquinolinium, etc.), and so forth. In one particular embodiment, for example, the cationic species may be an N-spirobicyclic compound, such as symmetrical or asymmetrical N-spirobicyclic compounds having cyclic rings. One example of such a compound has the following structure:

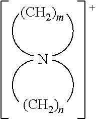

wherein m and n are independently a number from 3 to 7, and in some embodiments, from 4 to 5 (e.g., pyrrolidinium or piperidinium).

In preferred embodiments, suitable cations include tetraethylammonium, triethylmethylammonium, spiro-(1,1′)-bipyrrolidinium, N,N′-dimethylpiperazine, and 1,1-dimethylpyrrolidinium.

Suitable counterions for the cationic species may likewise include halogens (e.g., chloride, bromide, iodide, etc.); sulfates or sulfonates (e.g., methyl sulfate, ethyl sulfate, butyl sulfate, hexyl sulfate, octyl sulfate, hydrogen sulfate, methane sulfonate, dodecylbenzene sulfonate, dodecylsulfate, trifluoromethane sulfonate, heptadecafluorooctanesulfonate, sodium dodecylethoxysulfate, etc.); sulfosuccinates; amides (e.g., dicyanamide); imides (e.g., bis(pentafluoroethyl-sulfonyl)imide, bis(trifluoromethylsulfonyl)imide, bis(trifluoromethyl)imide, etc.); borates (e.g., tetrafluoroborate, tetracyanoborate, bis[oxalato]borate, bis[salicylato]borate, etc.); phosphates or phosphinates (e.g., hexafluorophosphate, diethylphosphate, bis(pentafluoroethyl) phosphinate, tris (pentafluoroethyl)-trifluorophosphate, tris (nonafluorobutyl) trifluorophosphate, etc.); antimonates (e.g., hexafluoroantimonate); aluminates (e.g., tetrachloroaluminate); fatty acid carboxylates (e.g., oleate, isostearate, pentadecafluorooctanoate, etc.); cyanates; acetates; and so forth, as well as combinations of any of the foregoing.

Several examples of suitable ionic liquids may include, for instance, spiro-(1,1′)-bipyrrolidinium tetrafluoroborate, triethylmethyl ammonium tetrafluoroborate, tetraethyl ammonium tetrafluoroborate, spiro-(1,1′)-bipyrrolidinium iodide, triethylmethyl ammonium iodide, tetraethyl ammonium iodide, methyltriethylammonium tetrafluoroborate, tetrabutylammonium tetrafluoroborate, and/or tetraethylammonium hexafluorophosphate.

As indicated above, the ultracapacitor includes a first electrode and a second electrode. The first electrode contains a first current collector and the second electrode contains a second current collector. It should be understood that additional current collectors may also be employed if desired, particularly if the ultracapacitor includes multiple energy storage cells. The current collectors may be formed from the same or different materials. Regardless, each collector is typically formed from a substrate that includes a conductive metal, such as aluminum, stainless steel, nickel, silver, palladium, etc., as well as alloys thereof. Aluminum and aluminum alloys are particularly suitable for use in the present invention. The substrate may be in the form of a foil, sheet, plate, mesh, etc. The substrate may also have a relatively small thickness, such as about 200 micrometers or less, in some embodiments from about 1 to about 100 micrometers, in some embodiments from about 5 to about 80 micrometers, and in some embodiments, from about 10 to about 50 micrometers. Although by no means required, the surface of the substrate may be optionally roughened, such as by washing, etching, blasting, etc.

In certain embodiments, at least one of the first and second current collectors, and preferably both, also contain a plurality of fiber-like whiskers that project outwardly from the substrate. Without intending to be limited by theory, it is believed that these whiskers can effectively increase the surface area of the current collector and also improve the adhesion of the current collector to the corresponding electrode. This can allow for the use of a relatively low binder content in the first electrode and/or second electrode, which can improve charge transfer and reduce interfacial resistance and consequently result in very low ESR values. The whiskers are typically formed from a material that contains carbon and/or a reaction product of carbon and the conductive metal. In one embodiment, for example, the material may contain a carbide of the conductive metal, such as aluminum carbide (Al₄C₃).

The manner in which such whiskers are formed on the substrate may vary as desired. In one embodiment, for instance, the conductive metal of the substrate is reacted with a hydrocarbon compound. Examples of such hydrocarbon compounds may include, for instance, paraffin hydrocarbon compounds, such as methane, ethane, propane, n-butane, isobutane, pentane, etc.; olefin hydrocarbon compounds, such as ethylene, propylene, butene, butadiene, etc.; acetylene hydrocarbon compounds, such as acetylene; as well as derivatives or combinations of any of the foregoing. It is generally desired that the hydrocarbon compounds are in a gaseous form during the reaction. Thus, it may be desired to employ hydrocarbon compounds, such as methane, ethane, and propane, which are in a gaseous form when heated. Although not necessarily required, the hydrocarbon compounds are typically employed in a range of from about 0.1 parts to about 50 parts by weight, and in some embodiments, from about 0.5 parts by weight to about 30 parts by weight, based on 100 parts by weight of the substrate. To initiate the reaction with the hydrocarbon and conductive metal, the substrate is generally heated in an atmosphere that is at a temperature of about 300° C. or more, in some embodiments about 400° C. or more, and in some embodiments, from about 500° C. to about 650° C. The time of heating depends on the exact temperature selected, but typically ranges from about 1 hour to about 100 hours. The atmosphere typically contains a relatively low amount of oxygen to minimize the formation of a dielectric film on the surface of the substrate. For example, the oxygen content of the atmosphere may be about 1% by volume or less.

The ultracapacitor of the present invention also contains first and second carbonaceous coatings that are electrically coupled to the first and second current collectors, respectively. The first and second electrodes may also be double-sided coated electrodes, such that both sides of the first and/or second current collectors have carbonaceous coatings. Thus, in certain embodiments, the first current collector has a first carbonaceous coating on a first side of the first current collector and a third carbonaceous coating on a second and opposite side of the first current collector. Likewise, in some embodiments, the second current collector has a second carbonaceous coating on a first side of the second current collector and a fourth carbonaceous coating on a second and opposite side of the second current collector. While the carbonaceous coatings may be formed from the same or different types of materials and may contain one or multiple layers, each of the carbonaceous coatings generally contains at least one layer that includes activated carbon particles, binders, and/or carbon black. In certain embodiments, for instance, the carbonaceous coating(s) may be directly positioned over the current collector. Examples of suitable activated carbon particles used in the carbonaceous coatings may include, for instance, potassium hydroxide (KOH) activated carbon, water steam activated carbon, coconut shell-based activated carbon, petroleum coke-based activated carbon, pitch-based activated carbon, polyvinylidene chloride-based activated carbon, phenolic resin-based activated carbon, polyacrylonitrile-based activated carbon, and activated carbon from natural sources such as coal, charcoal or other natural organic sources. In preferred embodiments, the first and second carbonaceous coatings comprise different materials. For instance, in preferred embodiments the first carbonaceous coating comprises KOH activated carbon and the second carbonaceous coating comprises water steam activated carbon. Further, in other embodiments, the first and third carbonaceous coatings comprise the same material while the second and fourth carbonaceous coatings comprise the same material.

In certain embodiments, the first carbonaceous coating and the second carbonaceous coating may comprise the same material. Even when the first carbonaceous coating and the second carbonaceous coating comprise the same materials, they may have different total porosity profiles. However, they may also have the same porosity profiles. For instance, in some embodiments, the second carbonaceous coating and the fourth carbonaceous coating may have the same particle and porosity profile as the first carbonaceous coating and the third carbonaceous coating. For example, at least 50% by volume of the particles (D50 size) may have a size in the range of from about 0.01 to about 30 micrometers, in some embodiments from about 0.1 to about 20 micrometers, and in some embodiments, from about 0.5 to about 10 micrometers. At least 90% by volume of the particles (D90 size) may likewise have a size in the range of from about 2 to about 30 micrometers, in some embodiments from about 5 to about 25 micrometers, and in some embodiments, from about 6 to about 15 micrometers. The BET surface area may also range from about 900 m²/g to about 2600 m²/g, in some embodiments from about 1,000 m²/g to about 2,400 m²/g, and in some embodiments, from about 1,100 m²/g to about 1,800 m²/g. In other embodiments, the activated carbon in the first, second, third, and/or fourth carbonaceous coating have a BET surface area of about 1630 m²/g to about 1720 m²/g.

In other embodiments, the second plurality of pores of the second carbonaceous coating has a second total pore volume, the second total pore volume comprising about 50 vol. % or more of pores having a median pore diameter size of about 2 nanometers (i.e., “micropores”) or less, such as about 55 vol. % or more of pores having a median pore diameter size of about 2 nanometers or less, such as about 60 vol. % or more of pores having a median pore diameter size of about 2 nanometers or less, such as about 65 vol. % or more of pores having a median pore diameter size of about 2 nanometers or less, such as about 70 vol. % or more of pores having a median pore diameter size of about 2 nanometers or less, such as about 75 vol. % or more of pores having a median pore diameter size of about 2 nanometers or less. In other embodiments, the second total pore volume comprises about 100 vol. % or less of pores having a median pore diameter size of about 2 nanometers or less, such as about 95 vol. % or less of pores having a median pore diameter size of about 2 nanometers or less, such as about 90 vol. % or less of pores having a median pore diameter size of about 2 nanometers or less, such as about 85 vol. % or less of pores having a median pore diameter size of about 2 nanometers or less. The total pore volume of the carbon particles in the second plurality of pores may be in the range of from about 0.2 cm³/g to about 2.0 cm³/g, and in some embodiments, from about 0.4 cm³/g to about 1.5 cm³/g. In certain embodiments, the total pore volume of the carbon particles in the second plurality of pores is about 0.97 cm³/g. In other embodiments, the single point adsorption total pore volume of pores less than about 3,650 Å at about p/p°=1.0 in the first and/or second carbonaceous coating is about 0.880 m³/g to about 0.916 m²/g.

The amount of pores between about 2 nanometers and about 50 nanometers in size (i.e., “mesopores”) may likewise be from about 20 vol. % to about 50 vol. %, in some embodiments from about 25 vol. % to about 45 vol. %, and in some embodiments, from about 35 vol. % to about 40 vol. % of the second pore volume. For instance, in some embodiments, the amount of pores between about 2 nanometers to about 50 nanometers in size may be about 5 vol. % or more, such as about 10 vol. % or more, such as about 15 vol. % or more, such as about 20 vol. % or more, such as about 25 vol. % or more, such as about 30 vol. % or more, such as about 35 vol. % or more, such as about 40 vol. % or more. In other embodiments, the amount of pores between about 2 nanometers to about 50 nanometers in size may be about 60 vol. % or less, such as about 55 vol. % or less, such as about 50 vol. % or less, such as about 45 vol. % or less.

The amount of pores greater than about 50 nanometers in size (i.e., “macropores”) may be from about 1 vol. % to about 50 vol. %, in some embodiments from about 5 vol. % to about 40 vol. %, and in some embodiments, from about 10 vol. % to about 35 vol. % of the second pore volume. For instance, in some embodiments, the amount of pores greater than about 50 nanometers in size may be about 1 vol. % or more, such as about 5 vol. % or more, such as about 10 vol. % or more, such as about 15 vol. % or more, such as about 20 vol. % or more, such as about 25 vol. % or more. In other embodiments, the amount of pores greater than about 50 nanometers in size may be about 50 vol. % or less, such as about 45 vol. % or less, such as about 40 vol. % or less, such as about 35 vol. % or less, such as about 30 vol. % or less.

In certain embodiments, the second plurality of pores of the second carbonaceous coating have a median pore diameter size, the counterion of the ionic liquid has a median ionic radius size, and the ultracapacitor demonstrates a ratio of the median pore diameter size of the second plurality of pores to the median ionic radius size of the counterion of from about 0.5 or greater, such as from about 0.6 or greater, such as from about 0.7 or greater, such as from about 0.8 or greater, such as from about 0.9 or greater, and such as from about 1.0 or greater. In other embodiments, the ratio of the median pore diameter size of the second plurality of pores to the median ionic radius size of the counterion is from about 1.5 or less, such as from about 1.4 or less, such as from about 1.3 or less, such as from about 1.2 or less, and such as from about 1.1 or less. In preferred embodiments, the ratio of the median pore diameter size of the second plurality of pores to the median ionic radius size of the counterion is about 0.95 to about 1.05. For instance, in certain embodiments, the ratio of the median pore diameter size of the second plurality of pores to the median ionic radius size of the counterion is about 0.95 or greater, such as about 0.96 or greater, such as about 0.97 or greater, such as about 0.98 or greater, such as about 0.99 or greater, such as about 1.0 or greater, In other embodiments, the ratio of the median pore diameter size of the second plurality of pores to the median ionic radius size of the counterion is about 1.05 or less, such as about 1.04 or less, such as about 1.03 or less, such as about 1.02 or less, such as about 1.01 or less.

Without intending to be limited by theory, the present inventors have also discovered that the ultracapacitor can demonstrate enhanced results in some embodiments when the first carbonaceous coating and the second carbonaceous coating comprise different materials, resulting in the second carbonaceous coating comprising a second total pore volume with a different size distribution and porosity profile than the first total pore volume. For instance, the second carbonaceous coating comprises activated carbon particles with a BET surface area of about 1,300 m²/g or greater, such as about 1,350 m²/g or greater, such as about 1,360 m²/g or greater, such as about 1,370 m²/g or greater. In other embodiments, the second carbonaceous coating comprises activated carbon particles with a BET surface area of about 1,450 m²/g or less, such as about 1,425 m²/g or less, such as about 1,400 m²/g or less, such as about 1,380 m²/g or less. In preferred embodiments, the second carbonaceous coating comprises activated carbon particles with a BET surface area of about 1,360 m²/g to about 1,370 m²/g. In other embodiments, the second carbonaceous coating may comprise a second plurality of pores having a second pore volume with a median diameter size of less than about 2 nanometers in size (i.e., “micropores”) of about 50 vol. % or less, such as 45 vol. % or less, such as 40 vol. % or less, such as 35 vol. % or less, such as about 30 vol. % or less, such as 25 vol. % or less, such as 20 vol. %

or less. In other embodiments, the second plurality of pores has a second pore volume with a median diameter size of less than about 2 nanometers of about 0.1 vol. % or more, such as about 0.5 vol. % or more, such as about 1 vol. % or more, such as about 5 vol. % or more, such as about 10 vol. % or more, such as about 15 vol. % or more. In some embodiments, the second plurality of pores has a second pore volume with a median diameter size of less than about 2 nanometers of from 0.1 vol. % to 15 vol. % of the second pore volume.

The amount of pores between about 2 nanometers and about 50 nanometers in size (i.e., “mesopores”) may likewise be from about 20 vol. % to about 100 vol. %, in some embodiments from about 25 vol. % to about 75 vol. %, and in some embodiments, from about 35 vol. % to about 65 vol. % of the second pore volume. For instance, in some embodiments, the amount of pores between about 2 nanometers to about 50 nanometers in size may be about 20 vol. % or more, such as about 25 vol % or more, such as about 30 vol. % or more, such as about 35 vol. % or more, such as about 40 vol. % or more, such as about 50 vol. % or more, such as about 60 vol. % or more, such as about 70 vol. % or more. In other embodiments, the amount of pores between about 2 nanometers to about 50 nanometers in size may be about 100 vol. % or less, such as about 90 vol. % or less, such as about 80 vol. % or less, such as about 75 vol. % or less, such as about 70 vol. % or less, such as about 65 vol. % or less, such as about 60 vol. % or less, such as about 55 vol. % or less, such as about 50 vol. % or less, such as about 45 vol. % or less.

The amount of pores greater than about 50 nanometers in size (i.e., “macropores”) may be from about 10 vol. % to about 100 vol. %, in some embodiments from about 5 vol. % to about 75 vol. %, and in some embodiments, from about 10 vol. % to about 50 vol. % of the second pore volume. For instance, in some embodiments, the amount of pores greater than about 50 nanometers in size may be about 1 vol. % or more, such as about 5 vol. % or more, such as about 10 vol. % or more, such as about 15 vol. % or more, such as about 20 vol. % or more, such as about 25 vol. % or more, such as about 30 vol. % or more, such as about 40 vol. % or more, such as about 45 vol. % or more, such as about 50 vol. % or more, such as about 55 vol. % or more, such as about 60 vol. % or more. In other embodiments, the amount of pores greater than about 50 nanometers in size may be about 100 vol. % or less, such as about 90 vol. % or less, such as about 80 vol. % or less, such as about 70 vol. % or less, such as about 60 vol. % or less, such as about 50 vol. % or less, such as about 45 vol. % or less, such as about 40 vol. % or less, such as about 35 vol. % or less, such as about 30 vol. % or less. The second total pore volume of the carbon particles in the second plurality of pores may be in the range of from about 0.2 cm³/g to about 2.0 cm³/g, and in some embodiments, from about 0.4 cm³/g to about 1.5 cm³/g. In other embodiments, the single point adsorption total pore volume of pores less than about 3,650 Å at about p/p°=1.0 in the second carbonaceous coating is about 0.770 m³/g or greater, such as about 0.780 m³/g or greater, such as about 0.790 m³/g or greater, and such as about 0.810 m³/g or less, such as about 0.800 m³/g or less. In certain embodiments, the single point adsorption total pore volume is about 0.786 m³/g.

In certain embodiments, the second plurality of pores has a median pore diameter size and the ratio of the median pore diameter size of the second plurality of pores to the median ionic radius size of the counterion is from about 1.5 to about 10.0. For instance, the ratio of the median pore diameter size of the second plurality of pores to the median ionic radius size of the counterion is from about 1.5 or more, such as about 2.0 or more, such as about 2.5 or more, such as about 3.0 or more, such as about 3.5 or more, such as about 4.0 or more, In other embodiments, the ratio of the median pore diameter size of the second plurality of pores to the median ionic radius size of the counterion is from about 10 or less, such as about 9 or less, such as about 8 or less, such as about 7 or less, such as about 6 or less, such as about 5.0 or less. In certain embodiments, the ratio of the median pore diameter size of the second plurality of pores to the median ionic radius size of the counterion is from about 1.5 to about 5.0.

It should also be understood that in some embodiments, the second electrode also includes a fourth carbonaceous coating. Thus, in certain embodiments, the second electrode includes a second carbonaceous coating on a first side of the second current collector and a fourth carbonaceous coating on a second and opposite side of the second current collector. In preferred embodiments, the fourth carbonaceous coating comprises the same material and the same porosity profile as the second carbonaceous coating. Thus, in some embodiments, both the second and fourth carbonaceous coatings comprise different materials and/or porosity profiles than the first and third carbonaceous coatings, respectively, resulting in the second and fourth carbonaceous coatings comprising a second total pore volume with a different size distribution and porosity profile than the first total pore volume.

The pore sizes and total pore volume for both the first carbonaceous coating and the second carbonaceous coating as discussed above may be measured using nitrogen adsorption and analyzed by the Barrett-Joyner-Halenda (“BJH”) technique as is well known in the art.

In certain embodiments, the electrodes need not contain a substantial amount of binders conventionally employed in ultracapacitor electrodes. That is, binders may be present in an amount of about 60 parts or less, in some embodiments 40 parts or less, and in some embodiments, from about 1 to about 25 parts per 100 parts of carbon in the first and/or second carbonaceous coatings. Binders may, for example, constitute about 15 wt. % or less, in some embodiments about 10 wt. % or less, and in some embodiments, from about 0.5 wt. % to about 5 wt. % of the total weight of a carbonaceous coating. Nevertheless, when employed, any of a variety of suitable binders can be used in the electrodes. For instance, water-insoluble organic binders may be employed in certain embodiments, such as styrene-butadiene copolymers, polyvinyl acetate homopolymers, vinyl-acetate ethylene copolymers, vinyl-acetate acrylic copolymers, ethylene-vinyl chloride copolymers, ethylene-vinyl chloride-vinyl acetate terpolymers, acrylic polyvinyl chloride polymers, acrylic polymers, nitrile polymers, fluoropolymers such as polytetrafluoroethylene or polyvinylidene fluoride, polyolefins, etc., as well as mixtures thereof. Water-soluble organic binders may also be employed, such as polysaccharides and derivatives thereof. In one particular embodiment, the polysaccharide may be a nonionic cellulosic ether, such as alkyl cellulose ethers (e.g., methyl cellulose and ethyl cellulose); hydroxyalkyl cellulose ethers (e.g., hydroxyethyl cellulose, hydroxypropyl cellulose, hydroxypropyl hydroxybutyl cellulose, hydroxyethyl hydroxypropyl cellulose, hydroxyethyl hydroxybutyl cellulose, hydroxyethyl hydroxypropyl hydroxybutyl cellulose, etc.); alkyl hydroxyalkyl cellulose ethers (e.g., methyl hydroxyethyl cellulose, methyl hydroxypropyl cellulose, ethyl hydroxyethyl cellulose, ethyl hydroxypropyl cellulose, methyl ethyl hydroxyethyl cellulose and methyl ethyl hydroxypropyl cellulose); carboxyalkyl cellulose ethers (e.g., carboxymethyl cellulose); and so forth, as well as protonated salts of any of the foregoing, such as sodium carboxymethyl cellulose and ammonium carboxymethyl cellulose.

If desired, other materials may also be employed within an activated carbon layer of the first and/or second carbonaceous coatings and/or within other layers of the first and/or second carbonaceous coatings. For example, in certain embodiments, a conductivity promoter may be employed to further increase electrical conductivity. Exemplary conductivity promoters may include, for instance, carbon black, graphite (natural or artificial), graphite, carbon nanotubes, nanowires or nanotubes, metal fibers, graphenes, etc., as well as mixtures thereof. Carbon black is particularly suitable. When employed, conductivity promoters typically constitute about 60 parts or less, in some embodiments 40 parts or less, and in some embodiments, from about 1 to about 25 parts per 100 parts of the activated carbon particles in a carbonaceous coating. Conductivity promotes may, for example, constitute about 15 wt. % or less, in some embodiments about 10 wt. % or less, and in some embodiments, from about 0.5 wt. % to about 5 wt. % of the total weight of a carbonaceous coating. Activated carbon particles likewise typically constitute 85 wt. % or more, in some embodiments about 90 wt. % or more, and in some embodiments, from about 95 wt. % to about 99.5 wt. % of a carbonaceous coating.

The particular manner in which a carbonaceous coating is applied to a current collector may vary as is well known to those skilled in the art, such as printing (e.g., rotogravure), spraying, slot-die coating, drop-coating, dip-coating, etc. Regardless of the manner in which it is applied, the resulting electrode is typically dried to remove moisture from the coating, such as at a temperature of about 100° C. or more, in some embodiments about 200° C. or more. The electrode may also be compressed (e.g., calendered) to optimize the volumetric efficiency of the ultracapacitor. After any optional compression, the thickness of each carbonaceous coating may generally vary based on the desired electrical performance and operating range of the ultracapacitor. Typically, however, the thickness of a singular coating is about 20 micrometers or greater, such as about 30 micrometers or greater, such as about 40 micrometers or greater, and generally about 100 micrometers or less, such as about 90 micrometers or less, such as about 80 micrometers or less. In other embodiments, the total thickness of the coating(s) on a single current collector is about 250 micrometers or less, such as about 200 micrometers or less, such as about 175 micrometers or less, such as about 170 micrometers or less, such as from about 150 micrometers or less, such as from about 100 micrometers or less. In certain embodiments, the thickness of the coating(s) ranges from about 145 to about 210 micrometers. For instance, the thickness of the carbonaceous coating(s) on the first electrode may be about 200 micrometers and the thickness of the carbonaceous coating(s) on the second electrode may be about 175 micrometers. Coatings may be present on one or both sides of a current collector. In some embodiments, a double-sided coating is more suitable for the ultracapacitor device. Thus, in other embodiments, the thickness of the carbonaceous coatings on the first electrode may include the combined thickness of the first carbonaceous coating and the third carbonaceous coating, while the thickness of the carbonaceous coatings on the second electrode may include the combined thickness of the second carbonaceous coating and the fourth carbonaceous coating.

In certain embodiments, the carbonaceous coating(s) of the first electrode has a first thickness, the carbonaceous coating(s) of the second electrode has a second thickness, and the ultracapacitor has a ratio of the first thickness to the second thickness of from about 1.1 to about 2.0. For instance, in certain embodiments, the ratio of the first thickness to the second thickness is about 1.1 or greater, such as about 1.2 or greater, such as about 1.25 or greater, such as about 1.3 or greater, such as about 1.35 or greater, such as about 1.4 or greater, such as about 1.5 or greater, such as about 1.6 or greater. In other embodiments, the ratio of the first thickness to the second thickness is about 2.0 or less, such as about 1.9 or less, such as about 1.8 or less, such as about 1.7 or less. In some embodiments, the ratio of the first thickness to the second thickness is about 1.25 to about 1.35. In preferred embodiments, the ratio of the first thickness to the second thickness is about 1.3.

Without intending to be limited by theory, the present inventors have discovered that when the positive electrode is thicker than the negative electrode, the resulting ultracapacitor can demonstrate higher voltage retention rates and higher specific capacitance. For instance, the present inventors have found that the positive electrode has a greater impact on the voltage retention rate of the ultracapacitor than the negative electrode, because the positive electrode has a high ion migration capability. According to Ohm's law, the voltage retention rate of the ultracapacitor is inverse to the cell voltage or electrode potential. Therefore, the higher the voltage, the lower the voltage retention rate, meaning the ultracapacitor is more likely to “self-discharge” and therefore not be a reliable energy source. Resultingly, the present inventors have found that by selectively controlling the thickness of the first electrode and the first carbonaceous coating, the resulting ultracapacitor is better suited for use in an energy reserve system.

For instance, the present inventors have found that the electrode thickness balance can be manipulated based on the specific electrolyte utilized based on these charge equations:

$${Q}_{+} = {C}_{+} * Δ {V}_{+}$$

wherein Q₊ is the charge of the first electrode, C₊ is the capacitance of the first electrode, and ΔV₊ is the change in voltage of the first electrode.
and

$${Q}_{-} = {C}_{-} * {Δ V}_{-}$$

wherein Q₋ is the charge of the second electrode, C₋ is the capacitance of the second electrode, and ΔV₋ is the change in voltage of the second electrode.

Due to the law of electroneutrality, therefore Q₊=C₊*ΔV₊=Q₋=C₋*ΔV.

Thus, if the first electrode is thicker than the second electrode, then

$${C}_{+} > {C}_{-} and Δ {V}_{+} < Δ {V}_{-}$$

Therefore, manipulating the change in voltage of the first electrode (e.g., ΔV₊) to be less than the change in voltage of the second electrode (e.g., Δ V₋) can help minimize the overall change of voltage for the ultracapacitor (e.g., voltage retention rate).

Regardless, the thickness of the overall electrode (including the current collector and the carbonaceous coating(s) after optional compression) is typically within a range of from about 20 to about 350 micrometers. For instance, in some embodiments, the thickness of the overall electrode is about 30 micrometers or greater, such as about 40 micrometers or greater, such as about 50 micrometers or greater, such as about 75 micrometers or greater, such as about 100 micrometers or greater, such as about 125 micrometers or greater, such as about 150 micrometers or greater, such as about 200 micrometers or greater. In other embodiments, the thickness of the overall electrode is about 350 micrometers or less, such as about 325 micrometers or less, such as about 300 micrometers or less, such as about 275 micrometers or less, such as about 250 micrometers or less, such as about 225 micrometers or less, such as about 200 micrometers or less. In some embodiments, the thickness of the overall electrode is from about 30 to about 300 micrometers such as from about 50 to about 250 micrometers.

As indicated, the ultracapacitor also includes a separator. The separator is positioned between the first and second electrodes. If desired, other separators may also be employed in the ultracapacitor of the present invention. For example, one or more separators may be positioned over the first electrode, the second electrode, or both. The separators enable electrical isolation of one electrode from another to help prevent an electrical short, but still allow transport of ions between the two electrodes. The separators can also act as electrolyte reservoirs. In certain embodiments, for example, a separator may be employed that includes a cellulosic fibrous material (e.g., airlaid paper web, wet-laid paper web, etc.), nonwoven fibrous material (e.g., polyolefin nonwoven webs), woven fabrics, film (e.g., polyolefin film), etc. Cellulosic fibrous materials are particularly suitable for use in the ultracapacitor, such as those containing natural fibers, synthetic fibers, etc. Specific examples of suitable cellulosic fibers for use in the separator may include, for instance, hardwood pulp fibers, softwood pulp fibers, rayon fibers, regenerated cellulosic fibers, etc.

Regardless of the particular materials employed, the separator typically has a thickness of from about 5 to about 150 micrometers, in some embodiments from about 10 to about 100 micrometers, and in some embodiments, from about 20 to about 80 micrometers. Without intending to be limited by theory, the present inventors have found that the thicker the separator, the higher the voltage retention rate is for the ultracapacitor, meaning that it is less likely to “self-discharge.” For instance, a thicker separator allows for more ions in the separator, which are harder to deplete after the ultracapacitor has been completely charged. For instance, if the ions were to be depleted from the separator, the conductivity of the electrolyte would decrease, resulting in a high ion concentration gradient which is more likely to influence self-discharge behavior of the ultracapacitor. Whereas, the thicker the separator, the more difficult it is to deplete the ions from the separator.

Additionally, the present inventors have found that the separator also serves as an electron insulator. For instance, the present inventors have also found that the resistance of the separator may also depend on the thickness and surface area of the separator. According to Ohm's law, which holds that current is equivalent to voltage/resistance (e.g., I=V/R), the ultracapacitor may have a lower leakage current, and therefore a lower self-discharge rate if the resistance of the ultracapacitor is higher.

The resulting ultracapacitor can still exhibit excellent electrochemical properties. For example, the ultracapacitor may exhibit a capacitance of about 6 Farads per cubic centimeter (“F/cm³”) or more, in some embodiments about 8 F/cm³ or more, in some embodiments from about 9 to about 100 F/cm³, and in some embodiments, from about 10 to about 80 F/cm³, measured at a temperature of 23° C., by IEC-6239-1, and with a rated voltage, such as about 2.7V to about 3.0V. ESR is measured by IEC-62391-1. The ESR value depends on total electrode surface area, electrode thickness, electrolyte conductivity and ultracapacitor design.

Notably, the ultracapacitor may also exhibit excellent electrochemical properties even when exposed to high temperatures. For example, the ultracapacitor may be placed into contact with an atmosphere having a temperature of from about 80° C. or more, in some embodiments from about 100° C. to about 150° C., and in some embodiments, from about 105° C. to about 130° C. (e.g., 85° C., 105° C. or 125° C.). The capacitance and ESR values can remain stable at such temperatures for a substantial period of time, such as for about 100 hours or more, in some embodiments from about 300 hours to about 5000 hours, and in some embodiments, from about 600 hours to about 4500 hours (e.g., 168, 336, 504, 672, 840, 1008, 1512, 2040, 3024, or 4032 hours).

In one embodiment, for example, the ratio of the capacitance value of the ultracapacitor after being exposed to the hot atmosphere (e.g., 85° C. or 105° C.) for 1008 hours to the capacitance value of the ultracapacitor when initially exposed to the hot atmosphere is about 0.75 or more, in some embodiments from about 0.8 to 1.0, and in some embodiments, from about 0.85 to 1.0. Such high capacitance retention values can also be maintained under various extreme conditions, such as when applied with a voltage and/or in a high humid atmosphere. For example, the ratio of the capacitance value of the ultracapacitor after being exposed to the hot atmosphere (e.g., 85° C. or 105° C.) and an applied voltage to the initial capacitance value of the ultracapacitor when exposed to the hot atmosphere but prior to being applied with the voltage may be about 0.60 or more, in some embodiments from about 0.65 to 1.0, and in some embodiments, from about 0.7 to 1.0. The voltage may, for instance, be about 1 volt or more, in some embodiments about 1.5 volts or more, and in some embodiments, from about 2 to about 10 volts (e.g., 2.1 volts). In one embodiment, for example, the ratio noted above may be maintained for 1008 hours or more. The ultracapacitor may also maintain the capacitance values noted above when exposed to high humidity levels, such as when placed into contact with an atmosphere having a relative humidity of about 40% or more, in some embodiments about 45% or more, in some embodiments about 50% or more, and in some embodiments, about 85% or more (e.g., about 85% to 95%). Relative humidity may, for instance, be determined in accordance with ASTM E337-02, Method A (2007). For example, the ratio of the capacitance value of the ultracapacitor after being exposed to the hot atmosphere (e.g., 85° C. or 105° C.) and high humidity (e.g., 85%) to the initial capacitance value of the ultracapacitor when exposed to the hot atmosphere but prior to being exposed to the high humidity may be about 0.7 or more, in some embodiments from about 0.75 to 1.0, and in some embodiments, from about 0.80 to 1.0. In one embodiment, for example, this ratio may be maintained for 1008 hours or more.

The ESR can also remain stable at such temperatures for a substantial period of time, such as noted above. In one embodiment, for example, the ratio of the ESR of the ultracapacitor after being exposed to the hot atmosphere (e.g., 85° C. or 105° C.) for 1008 hours to the ESR of the ultracapacitor when initially exposed to the hot atmosphere is about 1.5 or less, in some embodiments about 1.2 or less, and in some embodiments, from about 0.2 to about 1. Notably, such low ESR gain rate can also be maintained under various extreme conditions, such as when applied with a high voltage and/or in a humid atmosphere as described above. For example, the ratio of the ESR of the ultracapacitor after being exposed to the hot atmosphere (e.g., 85° C. or 105° C.) and an applied voltage to the initial ESR of the ultracapacitor when exposed to the hot atmosphere but prior to being applied with the voltage may be about 1.8 or less, in some embodiments about 1.7 or less, and in some embodiments, from about 0.2 to about 1.6. In one embodiment, for example, the ratio noted above may be maintained for 1008 hours or more. The ultracapacitor may also maintain the ESR values noted above when exposed to high humidity levels. For example, the ratio of the ESR of the ultracapacitor after being exposed to the hot atmosphere (e.g., 85° C. or 105° C.) and high humidity (e.g., 85%) to the initial capacitance value of the ultracapacitor when exposed to the hot atmosphere but prior to being exposed to the high humidity may be about 1.5 or less, in some embodiments about 1.4 or less, and in some embodiments, from about 0.2 to about 1.2. In one embodiment, for example, this ratio may be maintained for 1008 hours or more.

As indicated, the ultracapacitor of the present invention employs a housing within which the electrodes, electrolyte, and separator are retained and optionally hermetically sealed. Hermetic sealing is the process of creating an airtight container that prevents the leakage of gases, liquids, or solids. The housing may be slid over the ultracapacitor disclosed herein with multiple different forms of washers, collector discs, locknuts, flanges, lids, or combinations thereof. In some embodiments, the lid is drawn into the opening of the housing so that a rim of the lid sits inside a lip of the housing and is hermetically sealed via welding, crimping, adhesives, or any other method known in in the art.

For instance, in some embodiments, to enhance the degree of hermetic sealing, the housing generally contains a metal container (“can”), such as those formed from tantalum, niobium, aluminum, nickel, hafnium, titanium, copper, silver, steel (e.g., stainless), alloys thereof, composites thereof (e.g., metal coated with electrically conductive oxide), and so forth. Aluminum is particularly suitable for use in the present invention. The metal container may have any of a variety of different shapes, such as cylindrical, D-shaped, etc. Cylindrically-shaped containers are particular suitable.

In other embodiments, the housing may also comprise a flexible package. The flexible package generally includes a substrate that extends between two ends and that has edges. The ends and the sides of the package overlap and are fixedly and sealingly abutted against one another (e.g., by heat welding). In this manner, the electrolyte can be retained with the package. The substrate typically has a thickness within the range of from about 20 micrometers to about 1,000 micrometers, in some embodiments from about 50 micrometers to about 800 micrometers, and in some embodiments, from about 100 micrometers to about 600 micrometers.

The substrate of the flexible package may contain any number of layers desired to achieve the desired level of barrier properties, such as 1 or more, in some embodiments 2 or more, and in some embodiments, from 2 to 5 layers. Typically, the substrate contains a barrier layer, which may include a metal, such as aluminum, nickel, tantalum, titanium, stainless steel, etc. Such a barrier layer is generally impervious to the electrolyte so that it can inhibit leakage thereof, and also generally impervious to water and other contaminants. If desired, the substrate may also contain an outer layer that serves as a protective layer for the package. In this manner, the barrier layer is positioned between the outer layer and the electrode assembly. The outer layer may, for instance, be formed from a polymer film, such as those formed from a polyolefin (e.g., ethylene copolymers, propylene copolymers, propylene homopolymers, etc.), polyesters, etc. Particularly suitable polyester films may include, for example, nylon, polyethylene terephthalate, polyethylene naphthalate, polybutylene terephthalate, etc.

If desired, the substrate may also contain an inner layer that is positioned between the electrode assembly and the barrier layer. In certain embodiments, the inner layer may contain a heat-sealable polymer. Suitable heat-sealable polymers may include, for instance, polypropylene, polyethylene, vinyl chloride polymers, vinyl chloridine polymers, ionomers, etc., as well as combinations thereof. Ionomers are particularly suitable. In one embodiment, for instance, the ionomer may be a copolymer that contains an α-olefin and (meth)acrylic acid repeating unit. Specific α-olefins may include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Ethylene is particularly suitable. As noted, the copolymer may also a (meth)acrylic acid repeating unit. As used herein, the term “(meth)acrylic” includes acrylic and methacrylic monomers, as well as salts or esters thereof, such as acrylate and methacrylate monomers. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. Typically, the α-olefin/(meth)acrylic acid copolymer is at least partially neutralized with a metal ion to form the ionomer. Suitable metal ions may include, for instance, alkali metals (e.g., lithium, sodium, potassium, etc.), alkaline earth metals (e.g., calcium, magnesium, etc.), transition metals (e.g., manganese, zinc, etc.), and so forth, as well as combinations thereof. The metal ions may be provided by an ionic compound, such as a metal formate, acetate, nitrate, carbonate, hydrogen carbonate, oxide, hydroxide, alkoxide, and so forth.

The manner in which these components are inserted into the housing may vary as is known in the art. For example, the electrodes and separator may be initially folded, wound, or otherwise contacted together to form an electrode assembly. The electrolyte may optionally be immersed into the electrodes of the assembly. In one particular embodiment, the electrodes, separator, and optional electrolyte may be wound into an electrode assembly having a “jelly-roll” configuration.

The embodiments described above generally refer to the use of a single electrochemical cell in the capacitor. It should of course be understood, however, that the capacitor of the present invention may also contain two or more electrochemical cells. In one such embodiment, for example, the capacitor may include a stack of two or more electrochemical cells, which may be the same or different.

In other embodiments, however, a module may be formed that comprises at least two ultracapacitors that are conductively connected. The at least two ultracapacitors may be conducted in series or in parallel. Each ultracapacitor may be formed as disclosed herein. For instance, in certain embodiments, each ultracapacitor comprises a first electrode, a second electrode, a separator, a nonaqueous electrolyte, and a housing. The first electrode comprises a first current collector electrically coupled to a first carbonaceous coating that contains activated carbon particles having a first plurality of pores and the second electrode comprises a second current collector electrically coupled to a second carbonaceous coating that contains activated carbon particles having a second plurality of pores. The separator is positioned between the first electrode and the second electrode. The nonaqueous electrolyte is in ionic contact with the first electrode and the second electrode, wherein the nonaqueous electrolyte contains an ionic liquid comprising a cationic species and a counterion that is dissolved in a nonaqueous solvent. The first electrode, the second electrode, the separator, and the electrolyte are retained within the housing. The first plurality of pores of the first carbonaceous coating has a median pore diameter size, the counterion has a median ionic radius size, and the ultracapacitor has a ratio of the median pore diameter size of the first plurality of pores to the median ionic radius size of the counterion of from about 0.5 to about 1.5. In other embodiments, for instance, the at least two ultracapacitors demonstrate a voltage retention rate ratio of about 0.75 or more, such as about 0.85 or more, such as about 0.95 or more, such as about 0.99 or more. In other embodiments, the at least two ultracapacitors demonstrate a voltage retention rate ratio of about 1.25 or less, such as about 1.15 or less, such as about 1.05 or less. In some embodiments, the at least two ultracapacitors demonstrate a voltage retention rate ratio of about 0.75 to about 1.25. In some embodiments, the at least two ultracapacitors demonstrate a voltage retention rate ratio of about 0.95 to about 1.05. In preferred embodiments, the at least two ultracapacitors demonstrate a voltage retention rate ratio of about 1.

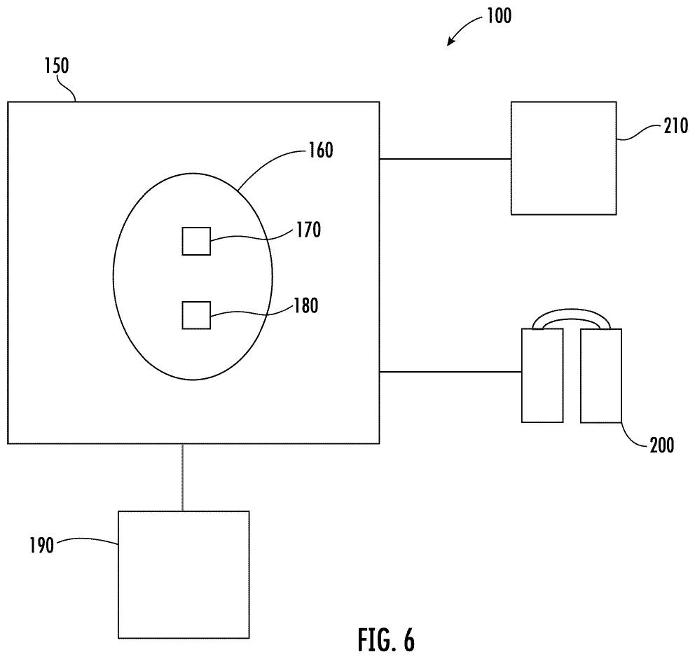

In another embodiment of the present disclosure, as demonstrated by FIG. 6, the ultracapacitor may be utilized in an energy reserve system 100 for an electronic latch assembly. Electronic latch (e.g. “e-latch”) assemblies may be used in a variety of applications, including but not limited to vehicles and asset security systems. For instance, electronic latch assemblies are particularly useful in vehicles, and can act as life-saving equipment when installed in vehicle doors. E-latch assemblies may be able to open vehicle doors by quickly releasing the ultracapacitor's energy when a main power supply, such as the battery, is disconnected due to an emergency, like an accident or loss of power.

In certain embodiments, the energy reserve system 100 for an electronic latch assembly comprises an electronic control unit 150 which is connected to a locking mechanism 190 of the electronic latch assembly and at least two ultracapacitors 200 that are conductively connected. The at least two ultracapacitors 200 may be conductively connected in series or in parallel.

The electric control unit 150 may include one or more controllers 160 and various other components configured to be communicatively coupled to and/or controlled by the controller(s) 160. It should be appreciated that the controller(s) 160 may correspond to any suitable processor-based device(s), such as a single controller or any combination of computing devices. Thus, as shown in FIG. 6, the controller(s) 160 may generally include one or more processors 170 and associated memory devices 180 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and any other programmable circuits. Additionally, the memory 180 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 180 may generally be configured to store information accessible to the processor(s) 160, including data that can be retrieved, manipulated, created and/or stored by the processor(s) 170 and instructions that can be executed by the processor(s) 170.

The energy reserve system 100 can also comprise a primary energy source 210, such as a battery. If the primary energy source 210 is operating properly, the primary energy source 210 can provide power to the electronic latch assembly such that the locking mechanism 190 can be configured to an unlocked position or locked position, depending on the user's preference. However, when the primary energy source 210 is not available, the electronic control unit 150 directs voltage from the at least two ultracapacitors 200 upon determining the primary energy source 210 is not available.

The electronic control unit 150 is configured to direct the voltage from the at least two ultracapacitors 200 such that the locking mechanism 190 can move the lock to either an unlocked or locked position. This allows users or passengers to be able to open the doors they need access to in a safe and timely manner. This is especially necessary for users in scenarios where the primary energy source 210 is no longer available, such as during emergencies or car accidents.

In certain embodiments, the energy reserve system 100 comprises at least two ultracapacitors. In preferred embodiments, for the energy reserve system to be a reliable source of energy, each ultracapacitor may comprise a first electrode, a second electrode, a separator, a nonaqueous electrolyte, and a housing. The first electrode comprises a first current collector electrically coupled to a first carbonaceous coating that contains activated carbon particles having a first plurality of pores and the second electrode comprises a second current collector electrically coupled to a second carbonaceous coating that contains activated carbon particles having a second plurality of pores. The separator is positioned between the first electrode and the second electrode. The nonaqueous electrolyte is in ionic contact with the first electrode and the second electrode, wherein the nonaqueous electrolyte contains an ionic liquid comprising a cationic species and a counterion that is dissolved in a nonaqueous solvent. The first electrode, the second electrode, the separator, and the electrolyte are retained within the housing. The first plurality of pores of the first carbonaceous coating has a median pore diameter size, the counterion has a median ionic radius size, and the ultracapacitor has a ratio of the median pore diameter size of the first plurality of pores to the median ionic radius size of the counterion of from about 0.5 to about 1.5. In other embodiments, for instance, the at least two ultracapacitors demonstrate a voltage retention rate ratio of about 0.75 or more, such as about 0.85 or more, such as about 0.95 or more, such as about 0.99 or more. In other embodiments, the at least two ultracapacitors demonstrate a voltage retention rate ratio of about 1.25 or less, such as about 1.15 or less, such as about 1.05 or less. In some embodiments, the at least two ultracapacitors demonstrate a voltage retention rate ratio of about 0.75 to about 1.25. In preferred embodiments, the at least two ultracapacitors demonstrate a voltage retention rate ratio of about 1.

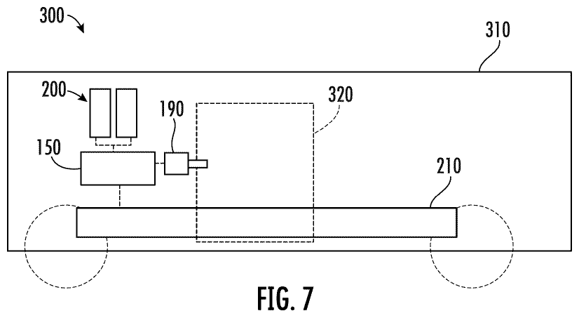

In another embodiment of the present disclosure, as shown in FIG. 7, the disclosure is directed to a vehicle 300 with an energy reserve system 100 for electronic latch assemblies. The vehicle 300 can comprise a frame 310 and at least one door 320. Vehicles can include, but are not limited to, a motor vehicle (e.g., cars, vans, trucks, carts, etc.), aircraft (e.g., airplanes, helicopters, etc.), watercraft (e.g., boats, ships, submersibles, submarines, etc.), and spacecraft. In certain embodiments, the energy reserve system comprises an electronic control unit 150 which is connected to a locking mechanism 190 of the electronic latch assembly. In certain embodiments, the electronic control unit 150 may also comprise the primary energy source 210, such as a battery. The energy reserve system 100 comprises at least two ultracapacitors 200 that are conductively connected. The at least two ultracapacitors 200 provide voltage to the electronic control unit 150 to configure the locking mechanism 190, for instance, upon determining the primary energy source 210 is not available.

In preferred embodiments, the at least two ultracapacitors employed in the vehicle with an energy reserve system comprise a first electrode, a second electrode, a separator, a nonaqueous electrolyte, and a housing. The first electrode comprises a first current collector electrically coupled to a first carbonaceous coating that contains activated carbon particles having a first plurality of pores and the second electrode comprises a second current collector electrically coupled to a second carbonaceous coating that contains activated carbon particles having a second plurality of pores. The separator is positioned between the first electrode and the second electrode. The nonaqueous electrolyte is in ionic contact with the first electrode and the second electrode, wherein the nonaqueous electrolyte contains an ionic liquid comprising a cationic species and a counterion that is dissolved in a nonaqueous solvent. The first electrode, the second electrode, the separator, and the electrolyte are retained within the housing. The first plurality of pores of the first carbonaceous coating has a median pore diameter size, the counterion has a median ionic radius size, and the ultracapacitor has a ratio of the median pore diameter size of the first plurality of pores to the median ionic radius size of the counterion of from about 0.5 to about 1.5. In other embodiments, for instance, the at least two ultracapacitors demonstrate a voltage retention rate ratio of about 0.75 or more, such as about 0.85 or more, such as about 0.95 or more, such as about 0.99 or more. In other embodiments, the at least two ultracapacitors demonstrate a voltage retention rate ratio of about 1.25 or less, such as about 1.15 or less, such as about 1.05 or less. In some embodiments, the at least two ultracapacitors demonstrate a voltage retention rate ratio of about 0.75 to about 1.25. In preferred embodiments, the at least two ultracapacitors demonstrate a voltage retention rate ratio of about 1.

Without intending to be limited by theory, the present inventors have found that when the at least two ultracapacitors display a minimum difference in their voltage retention rate and/or self-discharge behavior (e.g., wherein the at least two ultracapacitors demonstrate a voltage retention rate ratio of about 1), this results in a more reliable energy reserve system, as the ultracapacitors are less likely to provide false alarms and are more likely to maintain their voltage for when needed, such as an emergency situation. For instance, when the at least two ultracapacitors provide voltage to the electronic control unit, the locking mechanism can be configured to an unlocked position and the at least one door of the vehicle can be configured to open to allow for a passenger to exit the vehicle. The ability to utilize the disclosed energy reserve system in vehicles may result in life-saving capabilities and improved safety measures of electronic latch assemblies.

The present invention may be better understood with reference to the following example.

### Test Methods

### Equivalent Series Resistance (ESR)

Equivalence series resistance may be measured using a Hiller Instrument or Arbin Instrument by the IEC-62391 (2022) method. A variety of temperature levels may be tested. For example, the temperature may be 23° C., 65° C., 85° C. or 105° C. and the relative humidity may be 25% or 85%.

### Capacitance

The capacitance may be measured using a Hiller Instrument or Arbin Instrument by the IEC-62391 (2022) method. A variety of temperature levels may be tested. For example, the temperature may be 23° C., 65° C., 85° C. or 105° C., and the relative humidity may be 25% or 85%.

### Ionic Radius Size

The ionic radius is the effective distance between the nucleus's center and the electronic cloud where the ion exerts its influence. The ionic radius size may be measured using Pauling's method. Pauling's method holds that in an ionic crystal type of M⁺X⁻, cations and counterions are in contact with each other. Therefore, the sum of their ionic radius is equal to the interionic distance. Therefore, we can determine the value of the cationic radius or the counterion radius:

$${r}_{M}^{+} + {r}_{x}^{-} = ( c / ( {Z}_{eff} ( {M}^{+} ) ) + ( c / {Z}_{eff} ( {X}^{-} ) ) ( p m )$$

wherein Z_{eff} is the effective nuclear charge. Z_{eff}=Z−σ; where σ is the screening constant.

Therefore, the ionic radius of the cationic species is;

$${r}_{M}^{+} = ( c / ( {Z}_{eff} ( {M}^{+} ) )$$

and the ionic radius of the counterion is:

$${r}_{x}^{-} = ( c / {Z}_{eff} ( {X}^{-} ) )$$

### Voltage Retention Rate

The voltage retention rate (e.g. “self-discharge” rate) of a single ultracapacitor may be measured by aging the ultracapacitor for 16 hours at 65° C. and 2.7 volts before fully discharging to 0 volts at less two hours. The ultracapacitors were first charged to 2.5 volts using a constant current of 0.25 A, and held at 2.5 volts until the charging current was 10 mA. Once the charging current was 10 mA, the power source was turned off and the cell voltage was monitored for 16 hours. The difference in initial voltage when the power source was turned off to the final voltage tested after 16 hours is then calculated as the ultracapacitor's voltage retention rate. For instance:

$$Voltage Retention Rate \% = Δ V = ( {V}_{f} / {V}_{i} ) \times 100$$

Wherein V_{f} is the final voltage tested after 16 hours and Vᵢ is the initial voltage.

### Voltage Retention Rate Ratio

The voltage retention rate ratio between at least two ultracapacitors is calculated by dividing the voltage retention rate of each ultracapacitor. For example, if there are two ultracapacitors in a module:

$$Voltage Retention Rate \% of Ultracapacitor 1 = {ΔV}_{1} = ( {V}_{f 1} / {V}_{i 1} ) \times 100$$

$$and$$

$$Voltage Retention Rate \% of Ultracapacitor 2 = {ΔV}_{2} = ( {V}_{f 2} / {V}_{i 2} ) \times 100$$

$$and$$

$$Voltage Retention Rate Ratio = {Δ V}_{1} / {ΔV}_{2}$$

### EXAMPLE 1

### Electrode Thickness

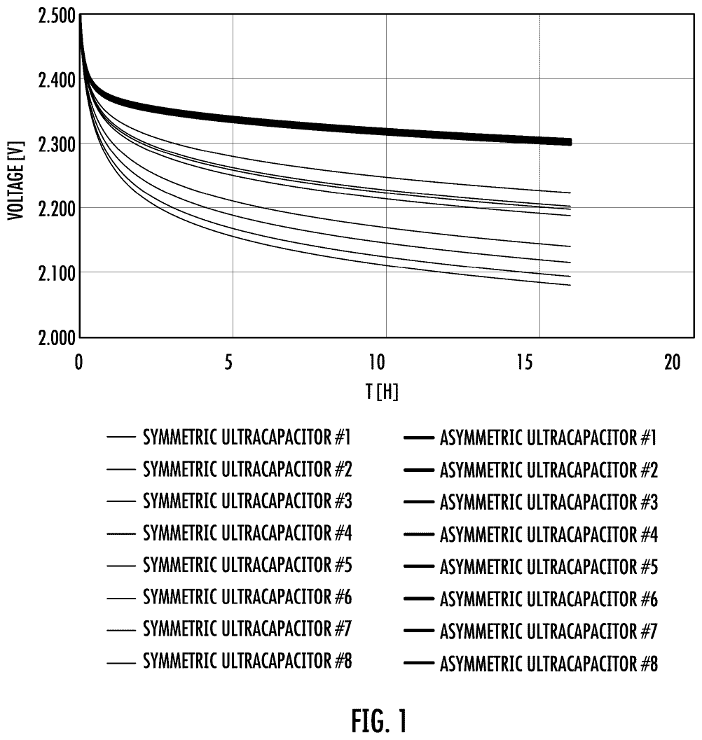

The ability to form an electrochemical cell in accordance with the present invention was demonstrated. Initially, each side of two aluminum current collectors (thickness of 12 to 50 μm) containing aluminum carbide whiskers or etched aluminum foil were coated with a mixture of 70-95 wt. % of activated carbon particles, 2-10 wt. % of a styrene-butadiene copolymer, and 1-5 wt. % of sodium carboxymethylcellulose. The activated carbon particles had a D50 size of about 5-20 μm and a BET surface area of about 1300-2200 m²/g. The thickness of the resulting coatings was either 175 μm or 200 μm. The electrodes were then calendered and dried under vacuum at a temperature of from 70° C. to 200° C. Once dried, the electrodes were slitted to the desired size. Once formed, the two electrodes were assembled with an electrolyte and a separator (cellulose material having a thickness of 25 μm or 30 μm) and wound to form “jelly rolls” according to the designed diameter size. For symmetric jelly rolls, the carbonaceous coating thickness was 200 μm for both the first and second electrodes. For asymmetric jelly rolls, the first electrode had a carbonaceous coating thickness of 200 μm and the second electrode had a carbonaceous coating thickness of 175 μm. The jelly rolls were then completely dried confirming by the Karl-Fischer titration method. After the jelly rolls were dried, the electrolyte containing spiro-(1,1′)-bipyrrolidinium tetrafluoroborate at a concentration of 1.5 M in sulfolane/dimethyl sulfone/acetonitrile was prepared. Eight symmetric jellyrolls and eight asymmetric jellyrolls were saturated with the electrolyte and inserted with an rubber gasket into an aluminum can and the aluminum can was then sealed by crimping. The resulting cells were formed, and their voltages were measured over 16 hours. The results are set forth in FIG. 1.

As demonstrated by FIG. 1, the ultracapacitors tested either had both first and second electrodes having a carbonaceous coating thickness of 200 μm or had a first electrode with a carbonaceous coating thickness of 200 μm and a second electrode with a carbonaceous coating thickness of 175 μm. FIG. 1 indicates that the ultracapacitors with differing carbonaceous coating thicknesses demonstrated a higher voltage retention rate.

### EXAMPLE 2

### Electrolytes

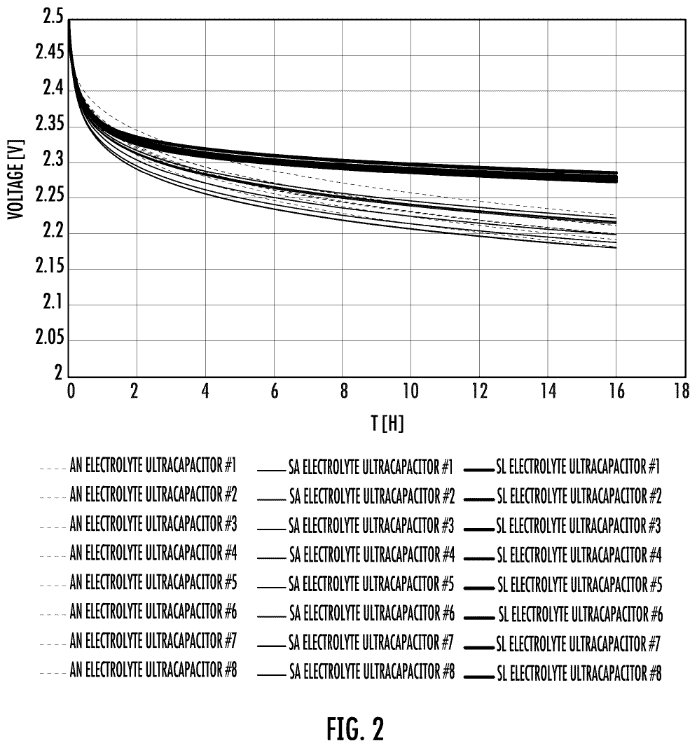

The jelly roll configurations of electrodes and separators were prepared, assembled, and dried in the same manner as described in Example 1, except that all the first electrodes had a carbonaceous coating thickness of 200 μm and all the second electrodes had a carbonaceous coating thickness of 175 μm. After the jelly rolls were dried, the various electrolytes at a concentration of 1.0 M according to Table 1 were prepared. Each electrolyte prepared according to Table 1 was used to saturate eight different jellyrolls. The jellyrolls were then placed into an aluminum can with a gasket and the aluminum can was then sealed by crimping. The resulting cells were formed, and their voltages were measured over 16 hours. The results are set forth in FIG. 2.

TABLE 1
Electrolytes Prepared for “AN” electrolyte, “SA”
electrolyte, and “SL” electrolyte.

| | “AN” Electrolyte | “SA” Electrolyte | “SL” Electrolyte |
|---|---|---|---|
| Ion(s) | spiro-(1,1′)- | spiro-(1,1′)- | spiro-(1,1′)- |
| | bipyrrolidinium | bipyrrolidinium | bipyrrolidinium |
| | tetrafluoroborate | tetrafluoroborate | tetrafluoroborate |
| Solvent(s) | acetonitrile | sulfolane/dimethyl | sulfolane/dimethyl |
| | | sulfone/acetonitrile | sulfone |

As demonstrated by FIG. 2, not all electrolytes have the same effect on voltage retention rate. For instance, even when tested using ultracapacitors with varying thicknesses of their carbonaceous coatings, FIG. 2 demonstrates that spiro-(1,1′)-bipyrrolidinium tetrafluoroborate has the greatest impact on improving voltage retention rate when dissolved in a solvent comprising sulfone/dimethyl sulfone.

### EXAMPLE 3

### Carbonaceous Coating Material and Pore Size

The electrodes and separators were prepared, assembled, and dried in the same manner as described in Example 1, except that all the first electrodes had a carbonaceous coating thickness of 200 μm, and the second electrodes had a carbonaceous coating thickness of either 170 μm or 200 μm. Additionally, the second electrode was configured to be 1 mm wider than that of the first electrode. The carbonaceous coatings on the first electrode comprised activated carbon with about 50 vol. % or more of pores having a median pore diameter size of about 2 nanometers (i.e., “micropores”) or less, such as greater than about 65 vol. % or more of pores having a median pore diameter size of about 2 nanometers or less, such as greater than about 75 vol. % or more of pores having a median pore diameter size of about 2 nanometers or less. The BET Surface Area of the activated carbon of the first carbonaceous coating was from about 1600 m²/g to about 1750 m²/g. The single point adsorption total pore volume of pores less than 3,604.993 Å width at p/p°=0.994729757 of the activated carbon in the first carbonaceous coating was from about 0.880 m³/g to about 0.916 m³/g.

The carbonaceous coatings on the second electrode comprised an activated carbon with median pore diameter sizes of less than about 2 nanometers in size (i.e., “micropores”) of about 50 vol. % or less and the amount of pores between about 2 nanometers and about 50 nanometers in size (i.e., “mesopores”) of from about 20 vol. % to about 80 vol. %, and the amount of pores greater than about 50 nanometers in size (i.e., “macropores”) may be from about 1 vol. % to about 50 vol. %. The BET Surface Area of the activated carbon of the second carbonaceous coating was from about 1350 m²/g to about 1400 m²/g. The single point adsorption total pore volume of pores less than 3,604.993 Å width at p/p°=0.994729757 of the activated carbon in the second carbonaceous coating was from about 0.700 m³/g to about 0.800 m³/g.

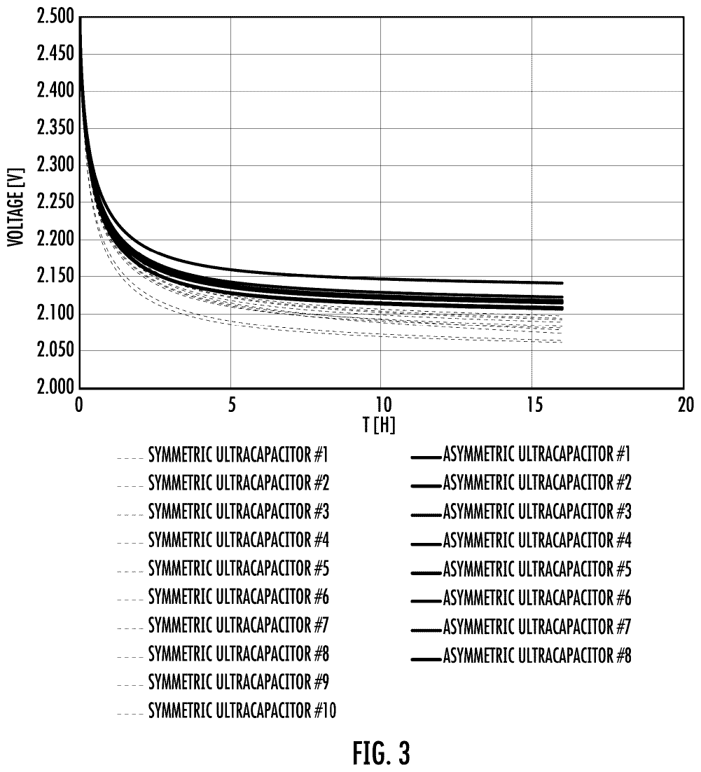

The ultracapacitor cells are pouch cells which consist of 7 electrodes total, comprising 4 second electrodes and 3 first electrodes. Ten symmetrical ultracapacitor cells and eight asymmetrical ultracapacitor cells were placed into a flexible pouch and then saturated with an electrolyte containing spiro-(1,1′)-bipyrrolidinium tetrafluoroborate at a concentration of 2.0 M in sulfolane/dimethyl sulfone. The ultracapacitor cells were then sealed. The capacity of the ultracapacitors was 20 F. The pouch cells were aged at 65° C. and 2.7 volts for 1948 hours, then run self-discharge test using the method mentioned in Example 2. The voltage retention rates of each pouch cell were then measured over 16 hours. The results are set forth in FIG. 3.

As demonstrated by FIG. 3, even when the first carbonaceous coating on the first electrode comprises more micropores and the second carbonaceous coating on the second electrode comprises more mesopores, the difference in carbonaceous coating thickness still impacts the voltage retention rate of the ultracapacitor cells.

### EXAMPLE 4

Carbonaceous Coating Material and Pore Size with Various Electrolytes

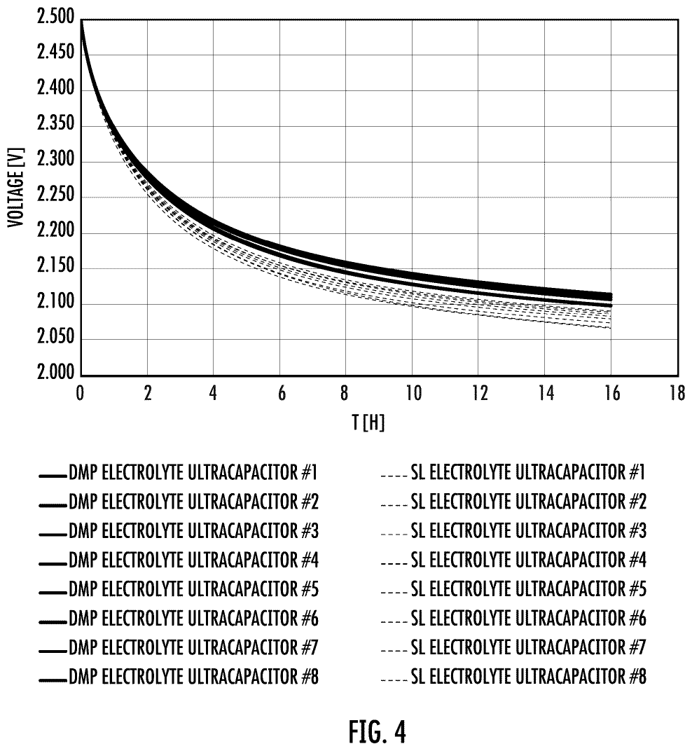

The ultracapacitor cell pouches were prepared in the same manner as in Example 3, except that the first and second electrodes were formed with the material used to form the second carbonaceous coating in Example 3 (e.g. a carbonaceous coating with a greater vol. % of mesopores). The carbonaceous coatings on both the first and second electrodes have a thickness of 200 μm. The ultracapacitor cell pouches were assembled and sealed in the same manner as in Example 3, except that various electrolytes at a concentration of 1.0 M according to Table 2 were prepared. Each electrolyte prepared according to Table 2 was used to saturate eight different ultracapacitor pouch cells. The pouch cells were then charged to 2.7 volts until the charging current was 2 mA. The voltage retention rates of each pouch cell were then measured over 16 hours. The results are set forth in FIG. 4.

TABLE 2
Electrolytes Prepared for “DMP” electrolyte and “SL” electrolyte.

| | “DMP” Electrolyte | “SL” Electrolyte |
|---|---|---|
| Ion(s) | 1,1- | spiro-(1,1′)- |
| | dimethylpyrrolidinium | bipyrrolidinium |
| | tetrafluoroborate | tetrafluoroborate |
| Solvent(s) | sulfolane/dimethyl | sulfolane/dimethyl |
| | sulfone | sulfone |

### EXAMPLE 5

### Carbonaceous Coating Material and Pore Size, Electrode Thickness, and Various Electrolytes

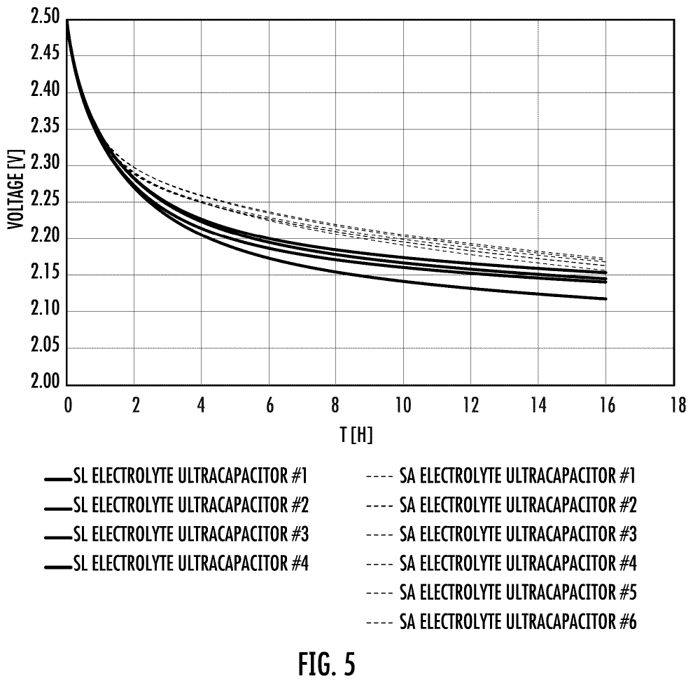

The ultracapacitor cell pouches were prepared in the same manner as in Example 3, except that the carbonaceous coatings on the first electrode had a thickness of 200 μm and the carbonaceous coatings on the second electrode had a thickness of 170 μm. The ultracapacitor cell pouches were assembled and sealed in the same manner as in Example 3, except that various electrolytes at a concentration of 1.5 M according to Table 3 were prepared. Each electrolyte prepared according to Table 3 was used to saturate different ultracapacitor cell pouches. The voltage retention rates of each pouch cell were then measured over 16 hours. The results are set forth in FIG. 5.

TABLE 3
Electrolytes Prepared for “SA” electrolyte and “SL” electrolyte.

| | “SA” Electrolyte | “SL” Electrolyte |
|---|---|---|
| Ion(s) | spiro-(1,1′)- | spiro-(1,1′)- |
| | bipyrrolidinium | bipyrrolidinium |
| | tetrafluoroborate | tetrafluoroborate |
| Solvent(s) | sulfolane/dimethyl | sulfolane/dimethyl |
| | sulfone/acetonitrile | sulfone |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. An ultracapacitor comprising:
a first electrode that comprises a first current collector electrically coupled to a first carbonaceous coating comprising activated carbon particles having a first plurality of pores;
a second electrode that comprises a second current collector electrically coupled to a second carbonaceous coating comprising activated carbon particles having a second plurality of pores;
a separator positioned between the first electrode and the second electrode;
a nonaqueous electrolyte in ionic contact with the first electrode and the second electrode, wherein the nonaqueous electrolyte contains an ionic liquid comprising a cationic species and a counterion dissolved in a nonaqueous solvent;
a housing within which the first electrode, the second electrode, the separator, and the nonaqueous electrolyte are retained;
and wherein the first plurality of pores of the first carbonaceous coating has a median pore diameter size, the counterion has a median ionic radius size, and a ratio of the median pore diameter size of the first plurality of pores to the median ionic radius size of the counterion is from about 0.5 to about 1.5.

2. The ultracapacitor of claim 1, wherein the ratio of the median pore diameter size of the first plurality of pores to the median ionic radius size of the counterion is about 0.95 to about 1.05.

3. The ultracapacitor of claim 1, wherein the first current collector, the second current collector, or both contain a substrate that includes a conductive metal comprising aluminum or an alloy thereof.

4. The ultracapacitor of claim 1, wherein the first carbonaceous coating, the second carbonaceous coating, or both have a thickness of about 200 micrometers or less.

5. The ultracapacitor of claim 1, wherein the first carbonaceous coating of the first electrode has a first thickness, the second carbonaceous coating of the second electrode has a second thickness, and wherein the ratio of the first thickness to the second thickness is from about 1.1 to about 2.0.

6. The ultracapacitor of claim 5, wherein the ratio of the first thickness to the second thickness is about 1.25 to about 1.35.

7. The ultracapacitor of claim 1, wherein the first carbonaceous coating comprises a KOH activated carbon.

8. The ultracapacitor of claim 1, wherein the second carbonaceous coating comprises a water steam activated carbon.

9. The ultracapacitor of claim 1, wherein the first plurality of pores has a first total pore volume, the first total pore volume comprising about 50 vol. % or more of pores having a median pore diameter size of about 2 nanometers or less.

10. The ultracapacitor of claim 1, wherein the second plurality of pores has a second total pore volume, the second total pore volume comprising about 50 vol. % or less of pores having a median pore diameter size of about 2 nanometers or less.

11. The ultracapacitor of claim 1, wherein the second plurality of pores has a median pore diameter size, and a ratio of the median pore diameter size of the second plurality of pores to the median ionic radius size of the counterion is from about 1.5 to about 10.0.

12. The ultracapacitor of claim 1, wherein the first electrode, the second electrode, or both have a thickness of from about 20 micrometers to about 350 micrometers.

13. The ultracapacitor of claim 1, wherein the ionic liquid is dissolved in the nonaqueous solvent at a concentration of 1.0 mole per liter or more.

14. The ultracapacitor of claim 1, wherein the cationic species has a median ionic radius size of about 0.1 to about 1.0 nanometers.

15. The ultracapacitor of claim 1, wherein the median ionic radius size of the counterion is from about 0.03 to about 1.0 nanometers.

16. The ultracapacitor of claim 1, wherein a ratio of a median ionic radius size of the cationic species to the median ionic radius size of the counterion in the ionic liquid is greater than about 2.5.

17. The ultracapacitor of claim 1, wherein the cationic species includes an organoquaternary ammonium compound.

18. The ultracapacitor of claim 17, wherein the organoquaternary ammonium compound has the following structure: 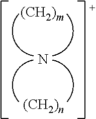
wherein m and n are independently a number from 3 to 7.

19. The ultracapacitor of claim 1, wherein the ionic liquid comprises spiro-(1,1′)-bipyrrolidinium tetrafluoroborate, triethylmethyl ammonium tetrafluoroborate, tetraethyl ammonium tetrafluoroborate, 1,1-dimethylpyrrolidinium tetrafluoroborate, spiro-(1,1′)-bipyrrolidinium iodide, triethylmethyl ammonium iodide, tetraethyl ammonium iodide, methyltriethylammonium tetrafluoroborate, tetrabutylammonium tetrafluoroborate, and/or tetraethylammonium hexafluorophosphate, or a combination thereof.

20. An energy reserve system for an electronic latch assembly comprising:
an electronic control unit connected to a locking mechanism of the electronic latch assembly;
at least two ultracapacitors conductively connected, wherein the at least two ultracapacitors provide voltage to the electronic control unit to configure the locking mechanism, further wherein each ultracapacitor comprises:
a first electrode that comprises a first current collector electrically coupled to a first carbonaceous coating that contains activated carbon particles having a first plurality of pores;
a second electrode that comprises a second current collector electrically coupled to a second carbonaceous coating that contains activated carbon particles having a second plurality of pores;
a separator positioned between the first electrode and the second electrode;
a nonaqueous electrolyte in ionic contact with the first electrode and the second electrode, wherein the nonaqueous electrolyte contains an ionic liquid comprising a cationic species and a counterion dissolved in a nonaqueous solvent;
a housing within which the first electrode, the second electrode, the separator, and the nonaqueous electrolyte are retained; and
wherein the first plurality of pores of the first carbonaceous coating has a median pore diameter size, the counterion has a median ionic radius size, and a ratio of the median pore diameter size of the first plurality of pores to the median ionic radius size of the counterion is from about 0.5 to about 1.5.

21. The energy reserve system of claim 20, wherein the at least two ultracapacitors demonstrate a voltage retention rate ratio of about 0.75 to about 1.25.

22. The energy reserve system of claim 20, further comprising a primary energy source,
wherein the electronic control unit directs voltage from the at least two ultracapacitors upon determining the primary energy source is not available.

23. A vehicle comprising:
a frame and at least one door,
an energy reserve system for an electronic latch assembly, the energy reserve system comprising:
an electronic control unit which is connected to a locking mechanism of the electronic latch assembly; and
at least two ultracapacitors conductively connected, wherein the at least two ultracapacitors provide voltage to the electronic control unit to configure the locking mechanism, further wherein each ultracapacitor comprises:
a first electrode that comprises a first current collector electrically coupled to a first carbonaceous coating that contains activated carbon particles having a first plurality of pores;
a second electrode that comprises a second current collector electrically coupled to a second carbonaceous coating that contains activated carbon particles having a second plurality of pores;
a separator positioned between the first electrode and the second electrode;
a nonaqueous electrolyte in ionic contact with the first electrode and the second electrode, wherein the nonaqueous electrolyte contains an ionic liquid comprising a cationic species and a counterion dissolved in a nonaqueous solvent;
a housing within which the first electrode, the second electrode, the separator, and the nonaqueous electrolyte are retained; and
wherein the first plurality of pores of the first carbonaceous coating has a median pore diameter size, the counterion has a median ionic radius size, and a ratio of the median pore diameter size of the first plurality of pores to the median ionic radius size of the counterion is from about 0.5 to about 1.5.

24. The vehicle of claim 23, wherein the at least two ultracapacitors demonstrate a voltage retention rate ratio of about 0.75 to about 1.25.

25. The vehicle of claim 23, wherein the locking mechanism can be configured to an unlocked position and the at least one door of the vehicle can be configured to open to allow for a passenger to exit the vehicle.
